(19) United States
(12) Patent Application Publication
(10) Pub. No.: US 2021/0319189 A1
(43) Pub. Date: Oct. 14, 2021

(54) MULTILINGUAL CONCIERGE SYSTEMS AND METHOD THEREOF

(71) Applicant: RAJIV TREHAN, BANGKOK (TH)

(72) Inventor: RAJIV TREHAN, BANGKOK (TH)

(21) Appl. No.: 17/224,415

(22) Filed: Apr. 7, 2021

Related U.S. Application Data
(60) Provisional application No. 63/007,351, filed on Apr. 8, 2020.

(51) Int. Cl. G06F 40/58; G06N 20/00; G06N 5/04; G10L 15/22; G10L 15/18

(52) U.S. Cl. CPC G06F 40/58; G06N 20/00; G06Q 10/10; G10L 15/22; G10L 15/1815; G06N 5/04

(57) ABSTRACT

The disclosure relates to system and method for providing multilingual concierge service. The method includes receiving verbal input from a user in a source language. The received verbal input is translated into an intermediate language to generate first translated verbal input. The first translated verbal input is matched with a set of predefined interaction workflows associated with an environment to identify a matching predefined interaction workflow. Further, the method includes determining an intent of the user using a natural language processing model. The method translates the first translated verbal input into a second translated verbal input. The second translated verbal input is routed to a response generating entity. A verbal response is received from the entity and is converted into the intermediate language to generate a first translated response. The method translates the first translated response to a second translated response and renders the second translated response to the user.

### CROSS-REFERENCE TO RELATED APPLICATIONS

This application claims priority benefits under 35 U.S.C. § 119(e) to U.S. Provisional Application No. 63/007,351 filed on Apr. 8, 2020, which is hereby incorporated by reference in its entirety.

### TECHNICAL FIELD

This disclosure relates generally to system and method for providing concierge services, and more particularly to method and system for providing a multilingual concierge system for providing services in multiple languages and method thereof.

### BACKGROUND

The impact of globalization on tourism and continuous expansion of cross-border business including migration and travel has resulted in massive changes in how, when, and where people communicate with each other in local communities for business, trade, political, economic, cultural, entertainment and other needs. Due to increase in frequency of international exchange, cross border industry players are growing very fast.

Conventionally, the hotel industry provides an in-house service system to a guest, in which the guest and the hotel are initialized on a mobile phone terminal, allowing for guest calling services whenever and wherever desired. In such cases, requests are evaluated by back office service assistants and forwarded to one of housekeepers, waiters, maintenance staff, or other hotel staff to attend to the request. The request may include, but is not limited to requirements of particular objects, washing, foods, maintenance needs, or cleaning. However, during times of higher hotel occupancy or low staff availability, often the hotel staff may not be able to perform services in a timely and efficient manner, especially when dealing with guests speaking a language other than language of the local staff working in the hotel.

Therefore, there is a need in the art for improved methods and systems for providing a multilingual concierge solution to enable delivering multiple levels of information in varied languages for timely and efficient management, control, and execution of a request raised by the user.

### SUMMARY

In an embodiment, a method for providing a multilingual concierge service is disclosed. In one example, the method may include receiving at least one verbal input from a user in a source language via a communication device. The at least one verbal input may be translated into an intermediate language to generate at least one first translated verbal input. The at least one first translated verbal input may be matched with a set of predefined interaction workflows associated with an environment to identify a matching predefined interaction workflow. Further, an intent of the user may be identified, via a natural language processing model, based on the at least one first translated verbal input and the matched predefined interaction workflow. Based on the identified intent, the method may translate the at least one first translated verbal input into at least one second translated verbal input. The at least one second translated verbal input may be in a target language. Each of the source language, the intermediate language, and the target language may be dissimilar. The method may further, based on the matched predefined interaction workflow and the identified intent, route the at least one second translated verbal input to a response generating entity. Further, a verbal response may be received from the response generating entity. The verbal response may be in the target language. The method may translate the verbal response into the intermediate language to generate at least one first translated response. Further, the at least one first translated response may be translated to at least one second translated response. The at least one second translated response may be in the source language. The method may render the at least one second translated response to the user.

In another embodiment, a multilingual concierge system is disclosed. In one example, the system may include a processor, and a memory communicatively coupled to the processor. The memory comprises processor instruction, which when executed by the processor cause the processor to receive, via a communication device, at least one verbal input from a user in a source language. The processor instructions, on execution, may further cause the processor to translate the at least one verbal input into an intermediate language to generate at least one first translated verbal input. The at least one first translated verbal input may be matched with a set of predefined interaction workflows associated with an environment to identify a matching predefined interaction workflow. The processor instructions, on execution, may further cause the processor to identify, via a natural language processing model, an intent of the user based on the at least one first translated verbal input and the matched predefined interaction workflow. The at least one first translated verbal input may be translated into at least one second translated verbal input, based on the identified intent. The at least one second translated verbal input may be in a target language. Each of the source language, the intermediate language, and the target language may be dissimilar. The processor instructions, on execution, may route the at least one second translated verbal input to a response generating entity, based on the matched predefined interaction workflow and the identified intent. Further, a verbal response may be received from the response generating entity. The verbal response is in the target language. The processor instructions, on execution, may translate the verbal response into the intermediate language to generate at least one first translated response. The at least one first translated response may be translated to at least one second translated response. The at least one second translated response may be in the source language. The at least one second translated response may be rendered to the user.

In another embodiment, a computer program product for providing a multilingual concierge service is disclosed. In one example, the computer program product is embodied in a non-transitory computer readable storage medium and comprises computer instructions for receiving, via a communication device, at least one verbal input from a user in a source language. The computer instructions may further include translating the at least one verbal input into an intermediate language to generate at least one first translated verbal input. The at least one first translated verbal input may be matched with a set of predefined interaction workflows associated with an environment to identify a matching predefined interaction workflow. Further, an intent of the user may be identified, via a natural language processing model, based on the at least one first translated verbal input and the matched predefined interaction workflow. Based on the identified intent, the computer instructions may translate the at least one first translated verbal input into at least one second translated verbal input. The at least one second translated verbal input may be in a target language. Each of the source language, the intermediate language, and the target language may be dissimilar. The computer instructions may further, based on the matched predefined interaction workflow and the identified intent, route the at least one second translated verbal input to a response generating entity. Further, a verbal response may be received from the response generating entity. The verbal response may be in the target language. The computer instructions may translate the verbal response into the intermediate language to generate at least one first translated response. Further, the at least one first translated response may be translated to at least one second translated response. The at least one second translated response may be in the source language. The computer instructions may render the at least one second translated response to the user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary process flow diagram for a multilingual concierge system, in accordance with some embodiments.

FIG. 2 illustrates a functional block diagram of a multilingual concierge system implemented by the exemplary system of FIG. 1, in accordance with some embodiments.

FIGS. 3A and 3B illustrate an exemplary process for providing a multilingual concierge service, in accordance with some embodiments.

FIG. 4 is a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

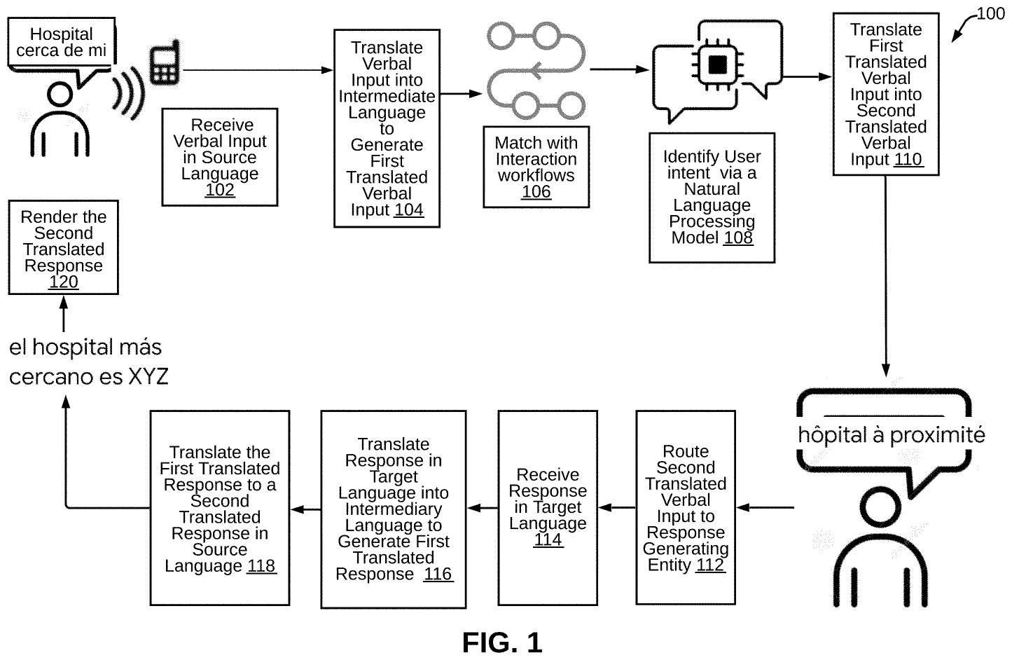

Referring now to FIG. 1, an exemplary process flow diagram for a multilingual concierge system 100 is illustrated, in accordance with some embodiments. In particular, process flow diagram may include receiving at least one verbal input in a source language from a user, at step 102. The at least one verbal input from the user may be converted to text using a Speech-to-Text (STT) algorithm. By way of an example, the user may be a Spaniard who may visit another country (non-Spanish speaking) as a tourist and may stay in a hotel there. Further, the user may only be comfortable speaking in Spanish. Thus, in this case, Spanish may be considered as a source language. The user may want to consult a general physician in a hospital nearby the hotel the user is staying at. To this end, the user may use a computing device to enquire about hospitals that may be located close to the hotel. The user may provide a verbal input in Spanish, for example, “hospital cerca de mi”. As may be appreciated, the computing device may be a mobile device such as but limited to a mobile phone, a tablet, a smartwatch, a laptop, and the like. As an example, the computing device may be at least one Internet of Things (IoT) devices that may be connected wirelessly to a central network of the hotel. Thus, in one implementation, the computing device may be a Property Management System (PMS) in a hotel or an interactive Kiosk placed in a public place. The IoT devices may be, for example, devices that may be designed to receive user input in any language including the source language, i.e., Spanish, in the current case. For example, when the user arrives in a room, a thermostat may be adjusted as per received verbal instructions from the user in the source language. Ambient lighting may be set to a lower intensity and/or a different color, in response to receiving verbal instructions from the user in the source language. Other smart IoT devices may include, but are not limited to a voice over IP (VoIP) phone or an IP phone integrated with property management systems (PMS) and/or a Private Branch Exchange (PBX) integration. The PMS and/or the PBX may request for a service or action to be provided or executed respectively upon receiving the verbal input from the user in the source language. As may be appreciated, integration of hotel telephone system and Hotel Management Software/PMS may be frequently required by hoteliers to streamline operations, unleash manpower, retain client data, and provide multiple timely records for the visiting users.

In an embodiment, the at least one verbal input in the source language may be translated into an intermediate language to generate at least one first translated verbal input, at step 104. For example, the received verbal input in the source language (for example, the Spanish language) from the user may be translated into the intermediate language (for example, the English language). Further, at step 106, the at least one first translated verbal input may be matched with a set of predefined interaction workflows associated with an environment to identify a matching predefined interaction workflow. The environment, for example, may correspond to a hotel, a hospital, or a public place. By way of an example, the first translated verbal input in the intermediate language (e.g., “hospital near me” in the English language) may be matched with a set of already defined interaction workflows. It will be apparent to a person skilled in the art that each environment may its own set of already defined interaction workflows. As an example, the interaction workflows may include a set of procedures or a sequence of interaction dialogues that may be used to accomplish an objective or provide a response to a user query, and this may be done by breaking down the interaction workflows into various segments. In continuation of the example above, the matched predefined interaction workflows may include, but are not limited to determining a set of hospitals within a defined distance from the hotel where the user is located, determining actual distance of the various hospitals located in close proximity to the hotel, reporting availability of the hospitals in an order varying from minimum distance to maximum distance from the hotel, and so forth. It will be apparent to a person skilled in the art that the aforementioned interaction workflow may include interactive dialogue exchange.

Additionally, an intent of the user may be identified based on the at least one first translated verbal input and the matched predefined interaction workflow, via a natural language processing (NLP) model, at step 108. The first translated verbal input may be processed by the NLP model. As an example, the first translated verbal input may be interpreted using the NLP model and determination of information or intent may be obtained thereof. The NLP model may be used to process and understand the intent and information extracted in machine translation of the verbal input for different languages. In some implementations, the NLP model may extract the intent from the user input, such as, needs, requirements, objectives, purpose, goals etc. For examples, a need for information, a purchase intent, a comment, a statement, a disagreement, etc. In an embodiment, the NLP model may identify the intent by performing an iterative and elastic matching of the one first translated verbal input and the matched predefined interaction workflow against a predefined intent map.

Typically, there may be three broad methods for processing natural language: statistically, grammatically, and through machine learning. The statistical approach may include word matching, keyword and synonym matching. Grammar and syntax processing may include a language grammar to understand part-of-speech (pos) and syntactic dependency parsing to extract information and intent. Lastly, machine learning may include machine learning to understand the probable intent and information from texts based on a corpus training data.

In an example, the verbal input may be translated to the intermediate language using machine translations. Further, the machine translations may result in poorly-structured and poorly-worded translations leading to limiting determination of the intents. To improvise on this, the intent of the user may be determined using predefined intent maps. The predefined intent maps may be constructed from a small example data set and may not be limited to verb, grammar, desire, question, location, and noun. Additionally, the intent may be identified through an iterative and elastic matching process in which initial intent-maps may be gradually manipulated and stretched by intent-consolidation, intent-refinement, intent-reduction and intent-synonym for determination of a best matching intent. As may be appreciated, an iterative and elastic process may be used to gradually loosen and stretch the intent-maps of the user input to identify the intent.

At step 110, the at least one first translated verbal input may be translated into at least one second translated verbal input, based on the identified intent. The at least one second translated verbal input may be in a target language. As an example, the target language may be a native language of the location where the hotel is located. In this example, the native language may be French. Based on the identified intent (for example, “determine hospitals located near me”, “identify and report hospitals located near to my current location”, “actual distance of the hospitals located near the hotel”, “way to reach the nearby hospitals”, etc.) the at least one first translated verbal input (in the English language) may be translated into at least one second translated verbal input (in the French language) as “hôpital à proximité”.

At step 112, based on the matched predefined interaction workflow and the identified intent, the at least one second translated verbal input may be routed to a response generating entity. The response generating entity may include, but may not be limited to at least one of a human attendant, a PMS, or an Interactive Voice Response (IVR) system. In continuation to the above mentioned example, the determined intent (e.g., “determine hospitals located me”) of the user may be matched to the predefined interaction workflow (including workflows e.g., to identify and determine hospitals located in close proximity to the hotel, determine corresponding distance between the hotel and the hospital, way to reach the hospitals, opening and closing time of the hospitals, list of practitioners visiting the hospital, etc.). In continuation of example above, the response generating entity may be, for example, the IVR system. Additionally, the IVR system may be at least one of a devices from a plurality of IoT devices that may be connected wirelessly to the central network of the hotel.

At step 114, a verbal response may be received from the response generating entity. The verbal response may be in the target language. By way of an example, when the intent is matched closely to at least one of workflow of the predefined interaction workflow, the response generating entity (e.g., the IVR system) may generate the verbal response that may be in line with the request as raised by the user. The generated verbal response (in French) may then be translated into the intermediate language, i.e., English, at step 116, to generate at least one first translated response. Further, the verbal response translated to the intermediate language may include responses, such as, but not limited to, “Hospital ‘A’ located closest to the hotel”, “Opening/Closing time for the hospital ‘A’”, and the like.

At step 118, the at least one first translated response may be translated to at least one second translated response. The at least one second translated response may be in the source language, i.e., Spanish, in the current case. In continuation of the above example, the first translated response (in the English language) may be translated to the second translated response (in the Spanish language). At step 120, the at least one second translated response may be rendered to the user. Further, the reply pertaining to the hospitals located near the hotel may be provided and rendered to the user (in the Spanish language) who generated the verbal input. In this example, the reply finally rendered to the user may be: “el hospital más cercano es XYZ.”

As may be appreciated by those skilled in the art, the translation from the source language to the intermediary language and from the intermediary language to the target language may be performed only when the source language is different from the intermediary language and the intermediary language is different from the target language. In case, the source language matches with the intermediary language, the need for translation may be obviated. Similarly, when the intermediary language is same as the target language the translation may not be performed.

It may further be appreciated that a response generating entity (for example, software Apps) may be able to generate response in multiple languages. In such cases, a response in the source language may directly be requested from the response generating entity, thereby avoiding any translations. By way of an example, the App AccurWeather™ has Application Programming Interface (API) in English, but can respond in a user defined output language.

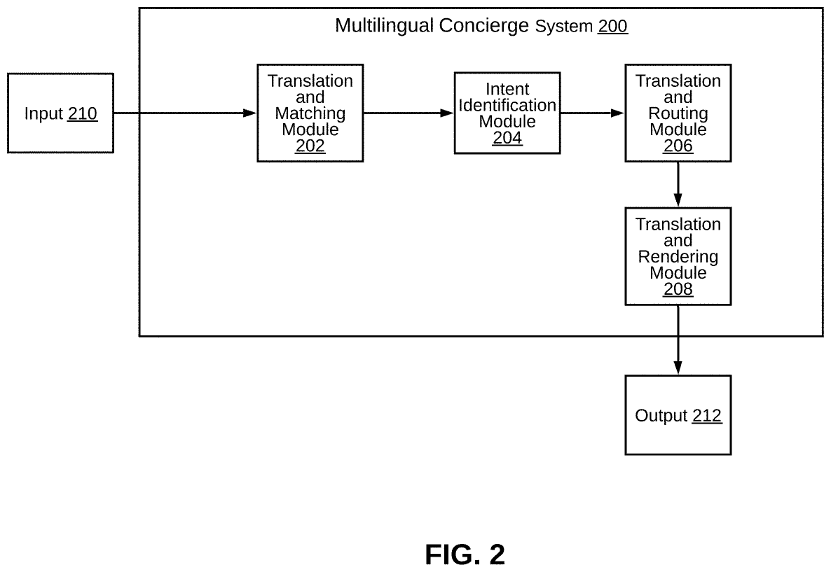

Referring now to FIG. 2, a functional block diagram of a multilingual concierge system 200 is illustrated, in accordance with some embodiments. In an embodiment, the multilingual concierge system 200 may include a translation and matching module 202, an intent identification module 204, a translation and routing module 206, and a translation and rendering module 208.

The translation and matching module 202 may receive an input 210. By way of an example, the input 210 may be at least one verbal input (for example, request for a service to be performed, request to receive/obtain information related to directions, cost, availability of a service/product etc.) received from a user. In an example, the at least one verbal input from the user may be in form of a word, a phoneme, a phoneme in context, a sentence, or a phrase. In another example, the at least one verbal input from the user may be converted to text using an STT algorithm. In an embodiment, the at least one verbal input may be translated into an intermediate language to generate at least one first translated verbal input. Further, the at least one first translated verbal input may be matched with a set of predefined interaction workflows associated with an environment to identify a matching predefined interaction workflow. In an exemplary embodiment, the received verbal input may be converted to text during the translation using automated STT mechanism and may again be converted to speech using Text-to-Speech (TTS) mechanism for rendering the translated response to the user. As may be appreciated, the multilingual concierge system 200 may receive the verbal input in multiple different languages and may generate a response in the source language of the user.

The intent identification module 204 may identify an intent of the user based on the at least one first translated verbal input and the matched predefined interaction workflow via an NLP model. In an example, the NLP model may be trained and configured to identify intent of the user in the intermediate language. In another exemplary embodiment, the STT/TTS mechanisms using the NLP model may enable performing intent analysis on the received input from the user to determine intents of the user (for example, intonation, persuasion, arguing, facilitating, etc.). The STT/TTS mechanisms may enhance and strengthen intent analytics of the received verbal input and may generate feedback loops for enhancing accuracy related to use of vocabulary, grammar, functions, etc. Further, the NLP model may bypass a requirement for receiving an exact (for example, grammatically correct) input from the user and may control a degree of error to accept (e.g., grammatically incorrect) input dialogs in multiple languages. It may be noted that the NLP model may only be trained in one language, for example, English. Moreover, as the source language is always converted to the same intermediate language, thus the NLP model is only required to be trained and configured using the intermediate language. This is further explained in detail by way of an example in the below paragraphs.

Based on the identified intent, the translation and routing module 206, may translate the at least one first translated verbal input into at least one second translated verbal input. The at least one second translated verbal input may be in a target language. Further, based on the matched predefined interaction workflow and the identified intent, the at least one second translated verbal input may be routed to a response generating entity. By way of an example, the response generating entity may include at least one of a human attendant, a PMS, or an IVR system. In an exemplary embodiment, the at least one second translated verbal input may be rendered to the response generating entity.

The translation and rendering module 208 may receive a verbal response from the response generating entity. The verbal response may be in the target language. The verbal response may then be translated into the intermediate language to generate at least one first translated response. Further, the at least one first translated response may be translated to at least one second translated response. The at least one second translated response may be in the source language of the user. The at least one second translated response may then be rendered to the user as output 212.

By way of an example, the response generating entity may at a given instance generate a response in multiple different languages. This may be done upon receiving a similar request from multiple users to receive the response (for example, weather information) in their respective source languages.

In an embodiment, in the system 200 the NLP model may be an English-centric multilingual machine translation model for translating the verbal input received in the source language to the intermediate language and from the intermediate language to the target language. By way of an example, for translating ‘Spanish’ to ‘French’ and back, the English-centric multilingual machine translation model may train on translating from ‘Spanish’ to ‘English’ and from ‘English’ to ‘French.’ The advantage of using the English-centric multilingual machine translation model is that training data in English is the most widely available. Additionally, by using the English-centric multilingual machine translation model, the system 200 may translate multiple languages based on the model thereby making the translation process faster and cost effective to roll out for new languages to be translated. As may be appreciated, the above translation example may not be construed to be only limited to translation from ‘Spanish’ to ‘English’ and may effectively work on translation of multiple languages using the English-centric multilingual machine translation model.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors. An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for identifying common requirements from applications. For example, the exemplary multilingual concierge system 200 may identify common requirements from applications by the processes discussed herein. In particular, as will be appreciated by those of ordinary skill in the art, control logic and/or automated routines for performing the techniques and steps described herein may be implemented by the multilingual concierge system 200 either by hardware, software, or combinations of hardware and software. For example, suitable code may be accessed and executed by the one or more processors on the system 200 to perform some or all of the techniques described herein. Similarly, ASICs configured to perform some or all of the processes described herein may be included in the one or more processors on the system 200.

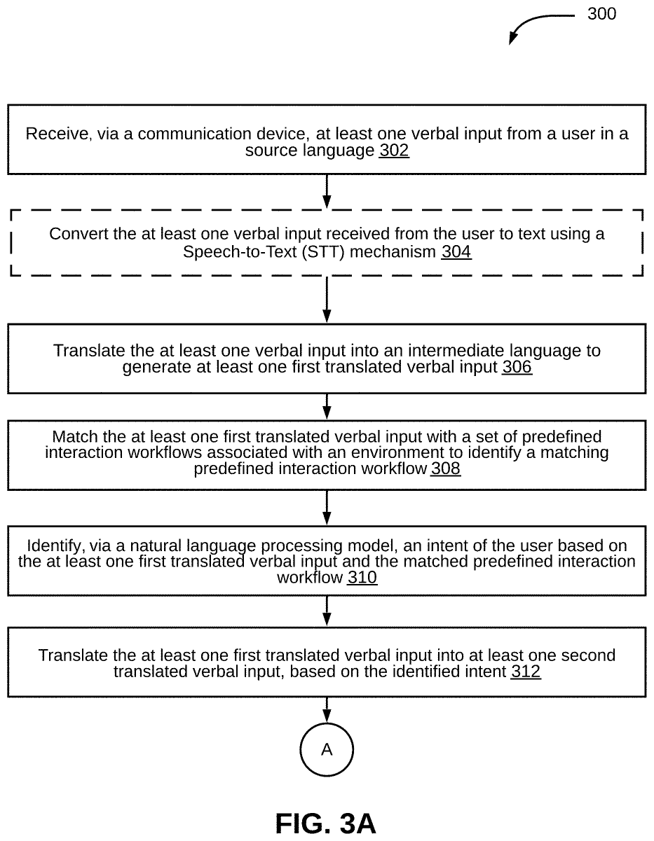

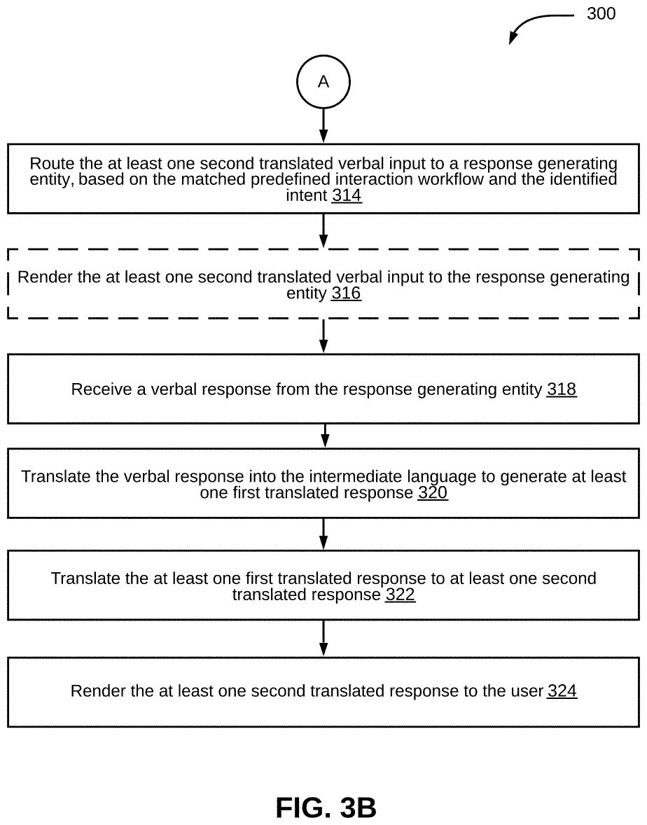

Referring now to FIGS. 3A and 3B, an exemplary process 300 for providing a multilingual concierge service is depicted via a flowchart, in accordance with some embodiments. The process 300 includes receiving at least one verbal input from a user in a source language, at step 302. As may be appreciated, the verbal input may be received via a communication device. The communication device may be a mobile device, such as, but not limited to a mobile phone, a tablet, a smartwatch, a laptop, and the like. By way of an example, the communication device may be at least one IoT devices that may be connected wirelessly to a central network. Thus, in one implementation, the communication device may be a PMS in a hotel or an interactive Kiosk placed in a public place. In an exemplary embodiment, the at least one verbal input from the user may be in the form of a word, a phoneme, a phoneme in context, a sentence or a phrase. In an embodiment, the process 300 may include converting the at least one verbal input received from the user to text using an STT mechanism at step 304.

Further, the process 300 may include translating the at least one verbal input into an intermediate language to generate at least one first translated verbal input, at step 306. In an exemplary embodiment, the at least one received verbal input may be converted to text using an STT mechanism. In an embodiment, the process 300 may include matching the at least one first translated verbal input with a set of predefined interaction workflows associated with an environment to identify a matching predefined interaction workflow, at step 308.

An intent of the user may be determined, via an NLP model, at step 310. The intent may be identified based on the at least one first translated verbal input and the matched predefined interaction workflow. In an exemplary embodiment, the natural language processing model may be trained and configured to identify intent in the intermediate language. The intermediate language, for example, may be English.

In an embodiment, the intent may be identified via the NLP model by performing an iterative and elastic matching of the at least one first translated verbal input and the matched predefined interaction workflow against a predefined intent map. This has already been explained in detail in conjunction with FIG. 1 and FIG. 2. Further, the process 300 may include, translating the at least one first translated verbal input into at least one second translated verbal input, based on the identified intent, at step 312. The at least one second translated verbal input is in a target language.

In an embodiment, the process 300 may route the at least one second translated verbal input to a response generating entity, based on the matched predefined interaction workflow and the identified intent, at step 314. In an embodiment, the at least one second translated verbal input may be rendered to the response generating entity, at step 316. In an exemplary embodiment, the response generating entity may include at least one of a human attendant, a PMS, or an IVR system. Further, the process 300 may receive a verbal response from the response generating entity, at step 318. It may be noted that the verbal response may be in the target language.

Further, the process 300 may translate the verbal response into the intermediate language to generate at least one first translated response, at step 320. In an embodiment, the process 300 may translate the at least one first translated response to at least one second translated response, at step 322. The at least one second translated response may be in the source language. The process may further render the at least one second translated response to the user, at step 324.

By way of an example, the system 200 and the method 300 may be used in a hospitality industry. A medium grade hotel may typically be visited by guests that may speak multifarious languages. This may pose a challenge for resource-poor or budget hotels. The reason being that providing multilingual customer service through a front desk manager who is proficient in multiple languages or multiple front managers each of whom are proficient in different languages may be cost ineffective. To overcome this challenge, the system 200 and the method 300 may be used. In an example, upon arrival of the guest, the guest may raise a voice based request in the source language (for example, local language of the guest) for additional towels to be provided in his room. The request may be transferred to a central server that is maintained by the hotel in the target language (for example, the local language of the area where the hotel is located). In response to the request, an automatic response that the requested towels are on the way may be generated by the server in the target language. Thereafter, the automatic response may be translated into the source language and may then be provided to the guest. Simultaneously, a message (verbal or textual) in the target language may be provided to a housekeeping personnel who may deliver the towels to the guest.

By way of another example, the system 200 and the method 300 may be used for performing financial services using a multilingual relation service for conducting Over the Counter (OTC) transactions, cross-selling, and up-selling of services. For example, a user may want to execute a transaction related to sale/purchase of shares. The user may use a computing device to generate a verbal input in a source language (for example, local language of the user) related to selling of 10,000 shares of a company. Upon receiving the user input, a request may be shared with a corresponding bank in real-time in a local target language (for example, local language of the area where the bank is located). The request may be received in the target language (local language of the area) while being intermediary converted to English language from the source language. The bank may generate a reply for the user in the source language related to receiving the transaction request and may ask for a voice command or a finger identification from the user to conduct a secure transaction. After the user provides the command or the finger authentication, the bank may reply in the target language that the transaction has been successfully executed. Subsequently, the user may receive a message (textual or verbal) in the source language. Additionally, the bank may reply with a new trade position statement in the target language which may then be provided back to the user in the source language.

By way of yet another example, the system 200 and the method 300 may be used in shopping malls for establishing and managing communication amongst the user and service providers in multiple languages. The system 200 and the method 300 may facilitate in providing services such as related to wayfinding, determining mall offers and promotions on behalf of tenants. For example, the user may want to know where the nearest coffee shops are. The user may provide a voice input in a source language (e.g., local language of the user) from any location in the mall for a coffee shop nearby. The voice input may be translated and provided to a concierge in a local target language (for example, local language of area where the mall is located) in real-time. The concierge may reply in the target language, which may be translated into the source language and may then be provided to the user either as a message, or a map showing where the coffee shop is located. Further, the concierge may send any offers, vouchers associated with the coffee shop that may be relevant for the user in the source language. Additionally, a request as received from the user in the source language may be translated in the local target language before being received by the coffee shop.

By way of another example, the system 200 and the method 300 may be used at airports. At airports, numbers of passenger present at a given time may be in thousands. With long layovers, the need to manage food and beverages, security and flight management, immigration control and smuggling, while providing multiple languages support at point of interaction between the passengers and airport concierge services may reduce time, reduce stress, save costs and provide better customer service outcomes. In an example, a traveler may want to check status of a delayed flight. The traveler may generate a voice input using a computing device while the traveler is at the airport (or before travelling to airport). The voice input may correspond to an enquiry generated in a source language (for example, local language of the traveler) about departure of the flight. Thereafter, the airport concierge may receive a request in a target language (for example, local language of area where the airport is located) and may reply in real-time in the target language with information pertaining to the flight departure schedule. The traveler may receive the information in the source language as a message (verbal or textual).

By way of yet another example, the system 200 and the method 300 may be used by government bodies. Typically, the government bodies may have to conduct meetings, interactions with international associations such as Meetings, Incentives, Conventions, Exhibitions (MICE) to promote trade and tourism. Multilingual solutions may help events conducted by these government bodies to be conducted more smoothly and may improve outcomes of meeting goals. For example, a government official may facilitate a guest to understand an agenda for a meeting by using the system 200 and the method 300. The guest may be provided the agenda in a target language (for example, local language of the guest's country). Further, the government official may receive a request related to the agenda in real-time in the source language (for example, local language of the country which the guest is visiting) from the guest who may have raised the request in the target language. Based on the request, the government official may send a reply in the source language which may be received by the guest in the target language in real-time.

By way of another example, the system 200 and the method 300 may be used in a scenario related to education. These days education sector is booming with demand to learn English language as well as other major world languages. Providing multi-language based services within education infrastructure may help bring in a steep rise in participation and learning curve of students. For example, a student attending a course at a university may raise a request in a source language (for example, local language of the student). The raised request may then be received by college administration in a target language (for example, local language of place where the college is located). The college administration may retrieve the student's record from a database in the target language and may send a reply corresponding to the request in the target language that may be received by the student in the source language. This may be facilitated by the system 200 and the method 300.

By way of yet another example, the system 200 and the method 300 may be used in organizations such as Non-Government Organizations (NGO) dealing with rehabilitation of migrants and conducting various charities. Typically, while shifting borders the migrants may need to stay in migrant camps as refugees/migrants and may need to avail various support services and charities. To provide a better communication medium amongst the migrants and to reduce tension and improve morale, providing a system that supports multi language translation may be helpful. In an example, the migrants may require help to understand about the facilities provided at the rehabilitation camp. A migrant may raise a voice request in a source language (for example, local language of the migrant) to avail a particular service. The system 200 provided at the rehabilitation camp may receive the request in the target language (for example, local language of the place where the rehabilitation camp is located) and may respond with appropriate answer in the target language. The generated response may be provided to the migrant in the source language. This may be facilitated by the system 200 and the method 300.

By way of another example, the system 200 and the method 300 may be used in a military organization. Military operations, especially peace-keeping missions around the world, would benefit from using a multi-language translation system as disclosed in the system 200. The system 200 may provide a real-time voice communication to defuse tensions, improve morale and build cultural and economic understanding amongst servicemen speaking varied languages. For example, in a ‘Hearts and Minds’ campaign in a war zone, a soldier may use the system to generate a request in a source language (for example, local language of the soldier) to enquire about campaign objectives. Operating head of the campaign may receive a message in a target language (for example, local language of place from where the operating head belongs). The operating head may determine about the enquired objectives and may respond in the target language. The soldier may receive the response in real-time in the source language.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

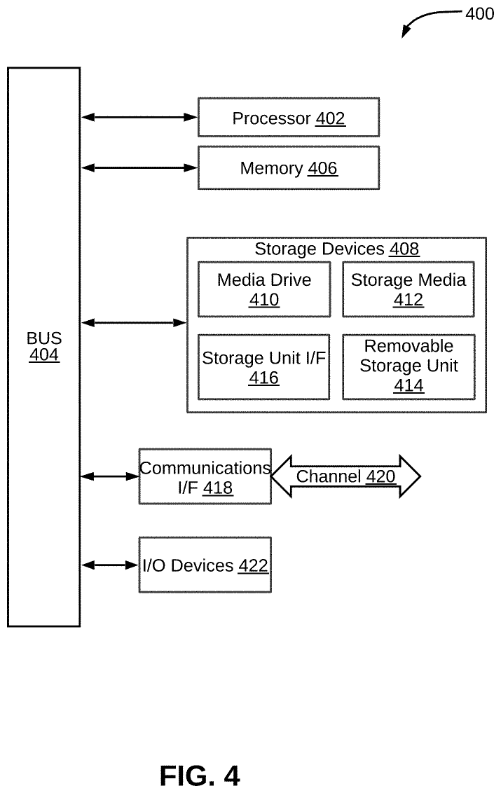

The disclosed methods and systems may be implemented on a conventional or a general-purpose computer system, such as a personal computer (PC) or server computer. Referring now to FIG. 4, an exemplary computing system 400 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 400 may represent, for example, a user device such as a desktop, a laptop, a mobile phone, personal entertainment device, DVR, and so on, or any other type of special or general-purpose computing device as may be desirable or appropriate for a given application or environment. The computing system 400 may include one or more processors, such as a processor 402 that may be implemented using a general or special purpose processing engine such as, for example, a microprocessor, microcontroller or other control logic. In this example, the processor 402 is connected to a bus 404 or other communication medium. In some embodiments, the processor 402 may be an Artificial Intelligence (AI) processor, which may be implemented as a Tensor Processing Unit (TPU), or a graphical processor unit, or a custom programmable solution Field-Programmable Gate Array (FPGA).

The computing system 400 may also include a memory 406 (main memory), for example, Random Access Memory (RAM) or other dynamic memory, for storing information and instructions to be executed by the processor 402. The memory 406 also may be used for storing temporary variables or other intermediate information during execution of instructions to be executed by the processor 402. The computing system 400 may likewise include a read only memory (“ROM”) or other static storage device coupled to bus 404 for storing static information and instructions for the processor 402.

The computing system 400 may also include a storage devices 408, which may include, for example, a media drive 410 and a removable storage interface. The media drive 410 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 412 may include, for example, a hard disk, magnetic tape, flash drive, or other fixed or removable medium that is read by and written to by the media drive 410. As these examples illustrate, the storage media 412 may include a computer-readable storage medium having stored therein particular computer software or data.

In alternative embodiments, the storage devices 408 may include other similar instrumentalities for allowing computer programs or other instructions or data to be loaded into the computing system 400. Such instrumentalities may include, for example, a removable storage unit 414 and a storage unit interface 416, such as a program cartridge and cartridge interface, a removable memory (for example, a flash memory or other removable memory module) and memory slot, and other removable storage units and interfaces that allow software and data to be transferred from the removable storage unit 414 to the computing system 400.

The computing system 400 may also include a communications interface 418. The communications interface 418 may be used to allow software and data to be transferred between the computing system 400 and external devices. Examples of the communications interface 418 may include a network interface (such as an Ethernet or other NIC card), a communications port (such as for example, a USB port, a micro USB port), Near field Communication (NFC), etc. Software and data transferred via the communications interface 418 are in the form of signals which may be electronic, electromagnetic, optical, or other signals capable of being received by the communications interface 418. These signals are provided to the communications interface 418 via a channel 420. The channel 420 may carry signals and may be implemented using a wireless medium, wire or cable, fiber optics, or other communications medium. Some examples of the channel 420 may include a phone line, a cellular phone link, an RF link, a Bluetooth link, a network interface, a local or wide area network, and other communications channels.

The computing system 400 may further include Input/Output (I/O) devices 422. Examples may include, but are not limited to a display, keypad, microphone, audio speakers, vibrating motor, LED lights, etc. The I/O devices 422 may receive input from a user and also display an output of the computation performed by the processor 402. In this document, the terms “computer program product” and “computer-readable medium” may be used generally to refer to media such as, for example, the memory 406, the storage devices 408, the removable storage unit 414, or signal(s) on the channel 420. These and other forms of computer-readable media may be involved in providing one or more sequences of one or more instructions to the processor 402 for execution. Such instructions, generally referred to as “computer program code” (which may be grouped in the form of computer programs or other groupings), when executed, enable the computing system 400 to perform features or functions of embodiments of the present invention.

In an embodiment where the elements are implemented using software, the software may be stored in a computer-readable medium and loaded into the computing system 400 using, for example, the removable storage unit 414, the media drive 410 or the communications interface 418. The control logic (in this example, software instructions or computer program code), when executed by the processor 402, causes the processor 402 to perform the functions of the invention as described herein.

Thus, the disclosed method and system try to overcome the problem of translating various inputs received in multiple languages from multiple users in real-time, thereby facilitating easy and clear communication amongst multiple users. Further, the method and system may provide a real-time cost effective multilingual concierge for enabling communication amongst the multiple users. Additionally, the disclosed method and system may enable the multiple users to issue specific task information requests in real-time in multiple languages using either of their computing device or by connecting their computing device to a central network available at their current location to avail the multilingual concierge.

As will be appreciated by those skilled in the art, the techniques described in the various embodiments discussed above are not routine, or conventional, or well understood in the art. The techniques discussed above may provide receiving, via a communication device, at least one verbal input from a user in a source language. The technique may translate the at least one verbal input into an intermediate language to generate at least one first translated verbal input. The at least one first translated verbal input may be matched with a set of predefined interaction workflows associated with an environment to identify a matching predefined interaction workflow. The technique may further identify, via a natural language processing model, an intent of the user based on the at least one first translated verbal input and the matched predefined interaction workflow. Further, the technique may translate the at least one first translated verbal input into at least one second translated verbal input, based on the identified intent. The at least one second translated verbal input may be routed to a response generating entity, based on the matched predefined interaction workflow and the identified intent. The technique may receive a verbal response from the response generating entity. The verbal response may be translate the verbal response into the intermediate language to generate at least one first translated response. The technique may further, translate the at least one first translated response to at least one second translated response. The at least one second translated response may be rendered to the user.

Moreover, the disclosed systems and method enable solving problems, limitations, and drawbacks existing in conventional voice controlled virtual digital assistants, which may be used to perform tasks or services based on vocal commands or questions generated by users. These virtual digital assistants may further be integrated with multiple other devices that may be connected to a central network (for example, an IoT based network). Thus, the virtual digital assistants may provide specific services related to lighting, music and the like. However, these virtual digital assistants do not specifically provide concierge services with respect to a request that may be specific to a situation, a locale and may correspond to real-time location of the user. Additionally, these virtual digital assistants may be programmed to receive instructions in a specific language only and may not facilitate language translations. This problem is solved by the disclosed method and systems of the present invention. More specifically, the disclosed method and system try to overcome the limitations of the conventional voice controlled virtual digital assistants by enabling multiple users to issue specific task information requests in real-time and that too in multiple languages. Additionally, in order to avail the multilingual concierge services as provided by the disclosed method and systems, a user may either use their computing device or may connect their computing device to the voice controlled virtual digital assistant, which may further be connected to the central network available at their current location).

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for providing multilingual concierge services. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A multilingual concierge system comprising:
a processor; and
a memory communicatively coupled to the processor, wherein the memory comprises processor instructions, which when executed by the processor cause the processor to:
receive, via a communication device, at least one verbal input from a user in a source language;
translate the at least one verbal input into an intermediate language to generate at least one first translated verbal input;
match the at least one first translated verbal input with a set of predefined interaction workflows associated with an environment to identify a matching predefined interaction workflow;
identify, via a natural language processing model, an intent of the user based on the at least one first translated verbal input and the matched predefined interaction workflow;
translate the at least one first translated verbal input into at least one second translated verbal input, based on the identified intent, wherein the at least one second translated verbal input is in a target language, and wherein each of the source language, the intermediate language, and the target language is dissimilar;
route the at least one second translated verbal input to a response generating entity, based on the matched predefined interaction workflow and the identified intent;
receive a verbal response from the response generating entity, wherein the verbal response is in the target language;
translate the verbal response into the intermediate language to generate at least one first translated response;
translate the at least one first translated response to at least one second translated response, wherein the at least one second translated response is in the source language; and
render the at least one second translated response to the user.

2. The multilingual concierge system of claim 1, wherein the natural language processing model is trained and configured to identify intent in the intermediate language.

3. The multilingual concierge system of claim 1, wherein the response generating entity comprises at least one of a human attendant, a property management system, or an Interactive Voice Response (IVR) system.

4. The multilingual concierge system of claim 1, wherein the processor instructions further cause the processor to render the at least one second translated verbal input to the response generating entity.

5. The multilingual concierge system of claim 1, wherein the at least one verbal input received from the user is in form of a sentence, a phrase, a word, a phoneme, or a phoneme in context.

6. The multilingual concierge system of claim 1, wherein the natural language processing model identifies the intent by performing an iterative and elastic matching of the one first translated verbal input and the matched predefined interaction workflow against a predefined intent map.

7. The multilingual concierge system of claim 1, wherein the at least one verbal input received from the user is converted to text using a Speech-to-Text (STT) mechanism.

8. A method for providing a multilingual concierge service, the method comprising:
receiving, via a communication device, at least one verbal input from a user in a source language;
translating the at least one verbal input into an intermediate language to generate at least one first translated verbal input;
matching the at least one first translated verbal input with a set of predefined interaction workflows associated with an environment to identify a matching predefined interaction workflow;
identifying, via a natural language processing model, an intent of the user based on the at least one first translated verbal input and the matched predefined interaction workflow;
translating the at least one first translated verbal input into at least one second translated verbal input, based on the identified intent, wherein the at least one second translated verbal input is in a target language, and wherein each of the source language, the intermediate language, and the target language is dissimilar;
routing the at least one second translated verbal input to a response generating entity, based on the matched predefined interaction workflow and the identified intent;
receive a verbal response from the response generating entity, wherein the verbal response is in the target language;
translating the verbal response into the intermediate language to generate at least one first translated response;
translating the at least one first translated response to at least one second translated response, wherein the at least one second translated response is in the source language; and
rendering the at least one second translated response to the user.

9. The method of claim 8, further comprising: training and configuring the natural language processing model to identify intent in the intermediate language.

10. The method of claim 8, wherein the response generating entity comprises at least one of a human attendant, a property management system, or an Interactive Voice Response (IVR) system.

11. The method of claim 8, further comprising: rendering the at least one second translated verbal input to the response generating entity.

12. The method of claim 8, wherein the at least one verbal input from the user is in form of a sentence, a phrase, a word, a phoneme, or a phoneme in context.

13. The method of claim 8, further comprising identifying the intent, via the natural language processing model, by performing an iterative and elastic matching of the one first translated verbal input and the matched predefined interaction workflow against a predefined intent map.

14. The method of claim 8, further comprising converting the at least one verbal input received from the user to text using a Speech-to-Text (STT) mechanism.

15. A computer program product being embodied in a non-transitory computer readable storage medium of a computing device associated with a multilingual concierge system and comprising computer instructions for:
receiving, via a communication device, at least one verbal input from a user in a source language;
translating the at least one verbal input into an intermediate language to generate at least one first translated verbal input;
matching the at least one first translated verbal input with a set of predefined interaction workflows associated with an environment to identify a matching predefined interaction workflow;
identifying, via a natural language processing model, an intent of the user based on the at least one first translated verbal input and the matched predefined interaction workflow;
translating the at least one first translated verbal input into at least one second translated verbal input, based on the identified intent, wherein the at least one second translated verbal input is in a target language, and wherein each of the source language, the intermediate language, and the target language is dissimilar;
routing the at least one second translated verbal input to a response generating entity, based on the matched predefined interaction workflow and the identified intent;
receive a verbal response from the response generating entity, wherein the verbal response is in the target language;
translating the verbal response into the intermediate language to generate at least one first translated response;
translating the at least one first translated response to at least one second translated response, wherein the at least one second translated response is in the source language; and
rendering the at least one second translated response to the user.

16. The computer program product of claim 15, further comprising training and configuring the natural language processing model to identify intent in the intermediate language.

17. The computer program product of claim 15, wherein the response generating entity comprises at least one of a human attendant, a property management system, or an Interactive Voice Response (IVR) system.

18. The computer program product of claim 15, further comprising: rendering the at least one second translated verbal input to the response generating entity.

19. The computer program product of claim 15, wherein the at least one verbal input from the user is in form of a sentence, a phrase, a word, a phoneme, or a phoneme in context.

20. The computer program product of claim 15, further comprising converting the at least one verbal input received from the user to text using a Speech-to-Text (STT) mechanism.
